(19) United States
(12) Patent Application Publication
(10) Pub. No.: US 2012/0134915 A1
(43) Pub. Date: May 31, 2012

(54) THIN NANO STRUCTURED LAYERS WITH HIGH CATALYTIC ACTIVITY ON NICKEL OR NICKEL ALLOY SURFACES AND PROCESS FOR THEIR PREPARATION

(76) Inventors: Francesco Celani, Ferentino (Frosinone) (IT); Misa Nakamura, Ferentino (Frosinone) (IT); Vittorio Di Stefano, Roma (IT); Marina Bonifazi Razzanti, Roma (IT); Paolo Marini, Roma (IT); Lorenzo Marini, Roma (IT); Filippo Marini, Firenze (IT)

(21) Appl. No.: 13/389,340

(22) PCT Filed: Aug. 9, 2010
(86) PCT No.: PCT/IB2010/053585

§ 371 Date: Feb. 7, 2012

(30) Foreign Application Priority Data
Aug. 7, 2009 (IT) TO2009A000626

(51) Int. Cl. C01B 3/00; B01J 21/06

(52) U.S. Cl. 423/648.1; 502/259

(57) ABSTRACT

Thin nano structured layers on surfaces of nickel or its alloys for quickly achieving high hydrogen adsorption values (H/Ni˜0.7) through direct metal/gas contact. The said layers are produced by a process comprising the step of oxidising the said surfaces, applying a film of aqueous silica sol to them, subsequent heating in an -oxidising atmosphere and final activation through reduction in a reducing atmosphere.

### INTRODUCTION

This invention relates to thin layers having high catalytic capacity produced on nickel surfaces and a process for obtaining them, the said layers being characterised by a very high specific surface area and the fact that they essentially comprise thermally-stable nanostructures. The said nanostructured layers are characterised by high adhesion to the substrate surface and high resistance to temperature and thermal shocks. Their catalytic properties are explained by the increase in capacity and speed of adsorption of hydrogen and its isotopes by nickel and its alloys.

In particular, through the technique of adsorption by direct Ni/H₂ contact, the invention makes it possible to obtain very high values of hydrogen adsorption in Ni (H/Ni atomic ratio≈0.7) quickly and economically. These storage values open up the possibility of using nickel as a source of hydrogen in fuel cells.

This invention may also be particularly useful in that field of experimental activity known to those skilled in the art by the names of Cold Fusion or Condensed Matter Nuclear Science, with the aim of generating heat of probably nuclear origin.

### STATE OF THE ART

It has been known for some time (e.g. M. L. Wyman et al. Bulletin of Alloy Phase Diagrams, Vol. 10, No. 5, 1989) that hydrogen adsorbed in nickel (atomic concentration: x=H/Ni) depends greatly on the activity of the atomic hydrogen (H) in equilibrium with molecular hydrogen (H₂). As is known, this activity increases very slowly with temperature and pressure. It has been found that at ambient temperature, and even at H₂ pressures of the order of 100 MPa, the x=H/Ni ratio is approximately 0.03.

In order to obtain H/Ni values and/or values for the rate of adsorption of hydrogen by nickel in a metal/gas system which are useful for the purposes described in the introduction it would be necessary to operate at pressures well above 100 MPa, that is such as to require complex and costly technology.

The situation changes radically if the adsorption is carried out by electrochemical means on Ni cathodes. This is due to the fact that high values of atomic hydrogen activity H can be obtained by working with suitable electrochemical procedures, such as e.g. the addition of inhibitors of the H+H→H₂ recombination reaction to the electrolytic solution, the performance of repeated loading (cathodic Ni)/discharge (anodic Ni) cycles at various current densities. H/Ni values of the order of 0.7 have been achieved with these methods using Raney nickel cathodes (A. Visintin et al., Electrochim. Acta (2006) 51 3658) (Univ. degli Studi di Bergamo, Design and Technology Department, Report on Activities 2007).

The effectiveness of electrochemical charging is associated with the fact that cathodic overvoltages of 0.2-0.5 V corresponding to energies of 0.2-0.5 eV per atom, which in turn correspond to extremely high equivalent pressures of H₂, well above 100 MPa, can be obtained by electrochemical means.

It has recently been shown that nanoparticles of nickel deposited on other metals such as e.g. magnesium, rare earths, zirconium (Cooper D. et al., Kona, vol. 23, page 139-151 (2005)) greatly increased the rate of hydrogen adsorption. On the other hand it has also been shown that palladium nanoparticles not only charge up extremely quickly, but reach charging levels x=H/Pd of 2-3, that is 2-3 times those which can be achieved through the cathodic charging of bulk Pd (Y. Arata and Y. Zhang: The special report on research project for creation of new energy. Journal of High Temperature Society, 2008, No. 1) (Y. Arata and Y. Zhang: Condensed Matter Nuclear Science, Proceedings of the 12th Int. Conference on Cold Fusion; ed. A. Takahashi, Y. Iwamura, and K. Ota). World Scientific 2006, pp. 44-54. ISBN: 981-256-901-4).

According to the authors of this invention, for one possible explanation of these phenomena it should be borne in mind that the surface energy of the nanoparticles is 3-4 times greater than that of the bulk metal because of their very high specific surface area (≈50 m²/g) (Nanda et al.—DOI: 10.1103/Phys. Rev. Lett. 91.106102) and that per atom in the surface, this energy can reach values close to those which can be achieved by electrochemical means (0.2-0.5 eV). Because the adsorption of atomic hydrogen substantially reduces surface energy (TROMANS D., Acta metallurgica et materialia ISSN 0956-7151, 1994, vol. 42, no. 6, pp. 2043-2049 (38 ref.)), this change in energy is in principle sufficient to justify the high adsorption values in metal nanoparticles.

As for the rate of hydrogen adsorption, it should be borne in mind that H/Ni charging levels of the order of 0.7 obtained by electrolytic means using Raney nickel cathodes require electrolysis times of the order of hours.

The primary object of this invention is therefore to provide a process for modifying the surface of a substrate of nickel or its alloys such that the surface modified in this way is capable of bringing about the direct adsorption of hydrogen and its isotopes at moderate pressures and temperatures, with very high hydrogen adsorption values.

Another object of the invention is to provide a process for the production of substrates or manufactured articles of nickel which are useful as a means for storing hydrogen (“storage media”) which can be used as a source of hydrogen, for example in fuel cells.

In view of these aims one object of the invention comprises a process as defined in the following claims.

Another object of the invention comprises a substrate or manufactured article of nickel or its alloys which can be obtained through the process according to the invention and which is likewise defined in the following claims.

In particular, the process according to the invention essentially comprises the following steps.

a) Oxidation of the surface of the nickel or nickel alloy substrate in order to obtain a thin layer of NiO acting as an anchoring layer.

The substrate used may be nickel or its alloys in massive or powder form; in the case of alloys it is preferable to use an alloy having a nickel content of more than 70% by weight. The substrate may likewise comprise manufactured articles of nickel or its alloys, such as for example sheets, bars or wires. Substrates of different materials, including inert materials, such as for example compact and/or porous ceramics, glass, various metals, including precious metals such as gold and platinum for example, provided with a surface deposit or coating of nickel or its alloys applied by techniques which are well known to those skilled in the art, may also be used.

Oxidation step a) is carried out by heating in an atmosphere which is oxidising for nickel; preferably step a) is performed by heating the nickel substrate (suitably degreased) in air to temperatures of between 300 and 1300° C., preferably between 800 and 1100° C. Preferably the oxidation step is carried out under conditions such as to produce an anchoring layer of nickel oxide in which the oxygen bound to nickel is not less than 0.05 g/m². The time of treatment in an oxidising atmosphere varies according to the temperature used and may be of the order of 10,000-300 seconds. For example for treatment temperatures of 800° C. a treatment (soaking) time of the order of approximately 1500 seconds is used, and at a temperature of 1100° C. the treatment time is of the order of approximately 300 seconds.

b) Application of colloidal silica to the nickel oxide anchoring layer.

In this step an aqueous sol of silica is preferably used to form a continuous liquid film over the entire surface. It is preferable that the dimensions of the silica particles should be less than 30 nm, and even more preferably less than 15 nm.

It is also preferable that the quantity of silica present in the liquid film on the oxidised surface of the metal should not be less than 0.1 g/m² and preferably not greater than 0.8 g/m². In step b) surfactants which are suitable for improving the wettability of the surface and for obtaining a continuous liquid film may be added to the silica sol. Salts of metals such as nickel, palladium, platinum, rhodium and iridium, which can be decomposed into their corresponding oxides by heating and air, and acid chemical compounds suitable for fostering chemical reactions between the nickel oxide and the silica, such as for example boric anhydride, phosphoric anhydride and chromic anhydride, may also be added to the silica sol. The silica sol may also comprise alkaline and alkaline earth oxides or salt precursors of such oxides in order to chemically stabilise the glassy film. It should be borne in mind that for every added mole of oxides of an alkaline nature (for example NiO, PdO, Na₂O, CaO, MgO) it is preferable that at least one mole of the aforesaid acid compounds should be added to the moles of basic SiO₂.

The sol may be applied as indicated above to the entire surface of the material treated according to step a), suitably cooled to ambient temperature, by various techniques such as for example combined spreading as a thin film by rollers or brushes, immersion in the solution and removal until completely drained, combined spraying by means of sprays or other similar known techniques. The aim is to obtain a continuous liquid film of uniform thickness over the entire surface. Preferably the total quantity of solid materials present in the liquid film is not less than 0.1 g/m².

c) Heating of the surface of the substrate resulting from step b) in air in order to foster the chemical reaction between the silica and the nickel oxide.

This step may be carried out at temperatures between 300 and 1300° C. for a time of between 1000 and 300 seconds, in a similar way to that previously described for step a).

In the case where the colloidal silica solution comprises the abovementioned compounds or salts of metals such as nickel, palladium, platinum, rhodium and/or iridium, one or more of the abovementioned acid compounds, or the abovementioned compounds of alkaline or alkaline earth metals having a vitrifying action on the silica, heating step c) is carried out at a temperature sufficient to cause vitrification of the silica.

Steps b) and c) may be repeated two or more times in order to increase the thickness of the layer obtained.

Optionally the process may comprise the steps of:

e) treatment of the surface of the substrate following step c) with an (aqueous) solution comprising an acid compound selected from phosphoric acid, chromic acid and boric acid or corresponding anhydrides or mixtures thereof, at least one alkaline or alkaline earth compound such as an oxide or a precursor salt of such oxides having a vitrifying action on silica and at least one water-soluble salt of a metal selected from nickel, palladium, platinum, rhodium, iridium or a mixture of the said salts, where the said solution optionally comprises colloidal silica, and
f) heating the substrate resulting from e) to a temperature sufficient to cause the silica to vitrify,
d) activating the product resulting from operating steps a), b) and c), and, if implemented, steps e) and f), in an atmosphere of hydrogen and/or its isotopes.

As a result of step d) the oxidised nickel is reduced to metallic nickel (activation of the product) and a thermally-stable nanostructure having high catalytic activity is produced in this way.

In order to carry out the treatment in reasonable times for practical purposes it is preferable to operate at temperatures above 120° C. and for times of not less than 50 seconds. It is desirable not to exceed 900° C. in order to prevent collapse of the nanostructures. This activation may also be performed by the end user for the purposes previously described.

### EXAMPLE 1

A sheet of 99.6% nickel (Ni 200—UNS NO2200/2.4060 & 2.4066) of 35×140×0.065 mm, having a total surface area considering the two sides of 98 cm², was carefully degreased with acetone and treated in a furnace beneath a light flow of pure argon at 550° C. for 30 minutes for the purpose of stress relieving and allowed to cool in argon in the cold zone of the furnace. The weight of the sheet after treatment was 2.8296±0.0002 g.

Subsequently the hot zone of the furnace was raised to 900° C. in a light flow of air. The sheet was placed in that zone and kept there for 1800 seconds (operation a)). The weight of the sheet after oxidation was 2.8333±0.0002 g. The oxygen fixed on the surface was therefore ≈0.53 g/m².

The sol used to stabilise the anchoring layer comprised colloidal silica with 12 nm micelles having an SiO₂ content of 30% by weight. The sol was diluted 1 to 20 with twice-distilled water. The sheet was immersed in the liquid at ambient temperature (24° C.) for 30 seconds, removed and allowed to drain for 60 seconds (operation b)). After this it was placed in the zone of the furnace at 900° C. in a light flow of air and kept there for 1200 seconds (operation c)).

The final weight of the sheet after this treatment was 2.8454±0.0002 g.

Operations a), b) and c) were repeated a second time. The final weight of the treated sheet was 2.8634±0.0002 g with a total increase in weight over the initial weight of 34 mg.

The sheet treated in this way was placed in a stainless steel container having a volume of 2.025 litres, fitted with a piezoelectric pressure measuring device. A 1.3·10⁻³ bar vacuum was applied. Subsequently argon was introduced at approximately 2 atmospheres and then a 1.3·10⁻³ mbar vacuum was applied again. When the temperature of the container was 26.5° C., the same as ambient temperature, hydrogen was introduced in order to raise the pressure to 1.1 bar within a few seconds. After 5000 seconds the pressure was almost stabilised at 0.93 bar (≈98% of the final equilibrium) at a temperature of 26.2° C. (ambient T 26.6° C.). It was thus possible to determine that the nickel sheet had adsorbed 0.014 moles of H₂ achieving an x=H/Ni atomic concentration of 0.58. The time of 5000 seconds is compatible with the diffusion coefficient shown in the literature, 2.0·10⁻⁹ cm²·s at 25° C. The x=H/Ni value of 0.58 is very close to that which can be obtained when the entire metal mass acts as a catalyst (Raney nickel), while in our case the thickness of the catalyst was a maximum of 1 μm.

### EXAMPLE 2

Five 99.5% nickel wires (each of diameter 200 μm, length 200 cm, lateral surface area 12.5 cm², overall weight of the 5 wires 2.7952 g) were each treated in the following way:
a) degreasing in 2M NaOH at 70° C.; washing in distilled H₂O; washing in acetone; final wash in distilled H₂O and drying in hot air.
b) each wire was heated to a temperature of approximately 1000° C. by Joule heating in air for a time of 400 seconds. The temperature was estimated by the change in the resistance of the wire.
c) after cooling each wire was coated with a solution of colloidal silica (30% by weight of SiO₂, sol dimensions 12 nm) in three passes with a brush.
d) each wire treated in this way was heated by Joule heating as in b). After cooling 5 wires were weighed again; an overall increase in weight of approximately 1.2 mg was recorded.
e) 20 ml of 85% by weight H₃PO₄, 100 ml of a 20% by weight solution of PdNO₃ and 100 ml of a 20% by weight solution of NiNO₃ were added to the colloidal silica solution (100 cm³).
f) the five wires were treated with the solution mentioned in e) using the means described in c).
g) finally the wires were heated by Joule heating as in b). After cooling the increase in weight in comparison with the bare wire was found to be approximately 2.3 mg.
h) the five wires, each inserted into a quartz-fibre sheath 0.2 cm in diameter and bent appropriately were placed in a cylindrical gas-tight stainless steel container (volume 2025 cm³) fitted with pressure and temperature sensors and held at a temperature of 150° C.
i) after vacuum had been applied hydrogen was quickly introduced into the container until it reached a pressure of 5 bar; the temperature of the container was held at 150° C. The Ni wire adsorbed hydrogen until it reached saturation in approximately 500 seconds; the H/Ni atomic ratio produced from the change in pressure was estimated to be 0.65.
l) the container containing the wire was evacuated and filled with air at ambient pressure; the temperature of the container was held at 100° C. in order to evaluate the discharge time for the wire. It was surprisingly found that after 600 hours the Ni wire retained its hydrogen content almost unchanged.

1-17. (canceled)

18. A process for producing a surface layer with catalytic activity on a substrate comprising at least one surface layer of nickel or its alloys, comprising the steps of:
a) oxidising the surface of the said substrate to obtain an anchoring layer of nickel oxide,
b) applying colloidal silica to the said anchoring layer,
c) heating the surface of the substrate resulting from step b) to a temperature between 300 and 1300° C., to promote the action between silica and nickel oxide, and
d) activation of the surface by treatment in a reducing atmosphere to reduce both its oxide and its silicates to nickel metal.

19. A process according to claim 18, wherein oxidation step a) is carried out by heating the said surface in an atmosphere which is oxidising for nickel at a temperature between 300 and 1300° C., preferably between 800 and 1100° C., for a time of between 10,000 and 300 seconds.

20. A process according to claim 18 or 19, wherein oxidation step a) is carried out in order to obtain an oxygen content bound to the nickel of not less than 0.05 g/m².

21. A process according to claim 18, wherein in step b) an aqueous silica sol capable of forming a continuous liquid film over the entire surface of the said substrate is used.

22. A process according to claim 21, wherein said silica sol comprises silica particles having dimensions of less than 30 nm, preferably less than 15 nm.

23. A process according to claim 18, wherein step b) is carried out by applying a colloidal silica sol to form a liquid film having a silica content of not less than 0.1 g/m².

24. A process according to claim 18, wherein the colloidal silica is an aqueous silica sol further comprising water-soluble salts of metals selected from the group comprising nickel, palladium, platinum, rhodium, iridium and mixtures thereof, the said soluble salts being capable of decomposing into their corresponding oxides when heated to a temperature lower than the temperature used in heating step c).

25. A process according to claim 18 or 24, wherein said colloidal silica or aqueous silica sol also comprises compounds selected from the group comprising boric acid, phosphoric acid, chromic acid and mixtures thereof.

26. A process according to claim 24, wherein said aqueous silica sol further comprises alkaline and/or alkaline-earth compounds which are totally soluble in the said aqueous silica sol.

27. A process according to claim 18, wherein said step c) is carried out by heating for a time of between 10,000 and 300 seconds.

28. A process according to claim 18, wherein said step c) is carried out by heating to a temperature sufficient to cause vitrification of the silica layer.

29. A process according to claim 18, wherein after step c) it comprises the step of:
e) treating the surfaces of the substrate with a solution comprising an acid compound selected from phosphoric acid, chromic acid and boric acid and mixtures thereof, at least one alkaline or alkaline earth compound which is a precursor of a vitrifying oxide and at least one water-soluble salt of a metal selected from nickel, palladium, platinum, rhodium, iridium or a mixture of the said salts, the said solution optionally including colloidal silica.

30. A process according to claim 29, wherein after step e) it comprises the step of:
f) heating the substrate to a temperature sufficient to cause vitrification of the silica.

31. A process according to claim 18, in which the said activation step d) comprises treatment of the substrate resulting from steps a), b) and c) or, if implemented, steps e) and f), in an atmosphere of hydrogen and/or its isotopes.

32. A process according to claim 31, wherein said treatment in a hydrogen atmosphere is carried out at temperatures between 120 and 900° and for a time of between 50 and 1200 seconds.

33. A process according to claim 31 or 32, wherein said substrate has a hydrogen/nickel atomic ratio of more than 0.3 following activation step d).

34. A method of storing hydrogen wherein hydrogen is stored in a substrate obtained by the method according to claim 18.
